(19) United States
(12) Patent Application Publication
(10) Pub. No.: US 2014/0080532 A1
(43) Pub. Date: Mar. 20, 2014

(54) METHOD AND SYSTEM FOR COMMUNICATION CHANNEL DISTRIBUTION

(71) Applicant: Agency for Science, Technology and Research, Singapore (SG)

(72) Inventor: Ser Wah OH, Singapore (SG)

(21) Appl. No.: 14/033,392

(22) Filed: Sep. 20, 2013

(30) Foreign Application Priority Data
Sep. 20, 2012 (SG) 201207003-3

(51) Int. Cl. H04W 72/10

(52) U.S. Cl. CPC H04W 72/10
USPC 455/512

(57) ABSTRACT

In various embodiments of the present disclosure, there is provided a method for communication channel distribution in a telecommunications frequency spectrum including: reserving, for a predetermined geographical location, at least one communication channel accessible at the predetermined geographical location for priority communication; and providing access to the at least one communication channel reserved for priority communication when a priority request criteria is satisfied. A corresponding system for communication channel distribution is provided.

### RELATED APPLICATIONS

This application claims the benefit of Singapore Patent Application no. 201207003-3, filed on 20 Sep. 2012. The disclosure of the above priority application is hereby incorporated by reference in its entirety.

### TECHNICAL FIELD

The present disclosure describes embodiments generally relating to a method and system for communication channel distribution.

### BACKGROUND

Spectrum management is an important area for consideration in the rapid growth and proliferation of wireless communications technology. Spectrum management can be understood to include the regulation of radio frequencies for more efficient usage. Radio frequency (RF) spectrum, which can be taken to be from 3 kHz to 300 GHz, is typically taken to be property of the state and is usually regulated nationally. Further, different bands within the RF spectrum are also allocated for various applications.

Recently, it has been raised by various bodies that most RF spectrum is inefficiently utilized. For example, cellular network bands are overloaded in most areas of the world, but most other frequencies, for example assigned to military, amateur radio, paging frequencies, etc., can be insufficiently utilized.

Cognitive radios in general and TV white spaces have received great attention in recent years due to their promises for better spectrum utilization in supporting the growth of wireless communications. Cognitive radios are radios which can be configured for dynamic operation. The transceiver of a cognitive radio is configured to select and utilize wireless channels in its range. The radio detects available channels in a wireless spectrum, then changes its transmission or reception parameters to allow for connection to a better communication channel for a particular location.

TV white space refers to the frequency band which has been left vacated by the exit of analog television, the range typically from 54 MHz to 806 MHz. Further, it can refer to any available spectrum space unutilized by television stations in a geographical area or time period. Various devices have been introduced to utilize such white space frequencies to transmit signals for, for example, internet connectivity. Such technology is touted to improve the availability of internet access in areas.

However, there is an uncertainty as to whether cognitive radios or TV white space devices are suitable for different types of communication especially when a certain level of quality of service (QoS) is required. For example, in the application of TV white spaces onto smart metering, although meter reading does not require real-time communication, special events such as top-up, account checking, tampering, etc. do require immediate attention. In the case when the spectrum is crowded, urgent data is not provided with any higher priority indication to be sent across.

There is as such a desire for a method and system for distributing communication channels efficiently.

### SUMMARY

According to various embodiments in the present disclosure, there is provided a method for communication channel distribution in a telecommunications frequency spectrum including: reserving, for a predetermined geographical location, at least one communication channel accessible at the predetermined geographical location for priority communication; and providing access to the at least one communication channel reserved for priority communication when a priority request criteria is satisfied.

In various embodiments, there is provided a system for communication channel distribution in a telecommunications frequency spectrum, including: a reservation module configured to reserve, for a predetermined geographical location, at least one communication channel for priority communication; and an access module configured to provide access to the at least one communication channel accessible at the predetermined geographical location reserved for priority communication when a priority request criteria is satisfied.

### BRIEF DESCRIPTION OF THE DRAWINGS

In the drawings, like reference characters generally refer to the same parts throughout the different views. The drawings are not necessarily to scale, with emphasis instead generally being placed upon illustrating the principles of the present disclosure. It is to be noted that the accompanying drawings illustrate only examples of embodiments of this disclosure and are therefore not to be considered limiting of its scope, for the disclosure may admit to other equally effective embodiments. In the following description, various embodiments of the disclosure are described with reference to the following drawings, in which:

FIG. 1 illustrates a communication channel distribution system according to an embodiment.

FIG. 2 illustrates a block diagram of a portion of an allocation engine according to an embodiment.

FIG. 3 illustrates a figurative representation of a range of communication channels according to an embodiment.

FIG. 4 illustrates a flow diagram of a channel distribution according to a first embodiment.

FIG. 5 illustrates a flow diagram of a channel distribution according to a second embodiment.

FIG. 6 illustrates a flow diagram of a channel distribution according to a third embodiment.

FIG. 7 illustrates a block diagram of a method according to an embodiment of the present disclosure.

FIG. 8 illustrates a block schematic of a system for communication channel distribution in a telecommunications frequency spectrum according to an embodiment of the present disclosure.

### DETAILED DESCRIPTION

Embodiments of a method and system for communication channel distribution are described in detail below with reference to the accompanying figures. However, it should be understood that the disclosure is not limited to specific described embodiments. It will be appreciated that the embodiments described below can be modified in various aspects, features, and elements, without changing the essence of the disclosure. Further, any reference to various embodiments shall not be construed as a generalization of any inventive subject matter disclosed herein and shall not be considered to be an element or limitation of the appended claims except where explicitly recited in a claim(s).

According to various embodiments, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” herein means “and/or” unless specifically indicated otherwise.

The present disclosure can describe embodiments of a consumer electronic device which can be operable in various orientations, and it thus should be understood that any of the terms “top”, “bottom”, “base”, “down”, “sideways”, “downwards” etc., when used in the following description are used for convenience and to aid understanding of relative positions or directions, and not intended to limit the orientation of the recording medium or a system or apparatus or product incorporating the recording medium.

According to various embodiments, one of the more promising ways of accessing underutilized spectrum dynamically is via Geo-Location DataBase (GLDB) management. GLDB provides a simpler and less arguable approach and is able to provide additional support for QoS support.

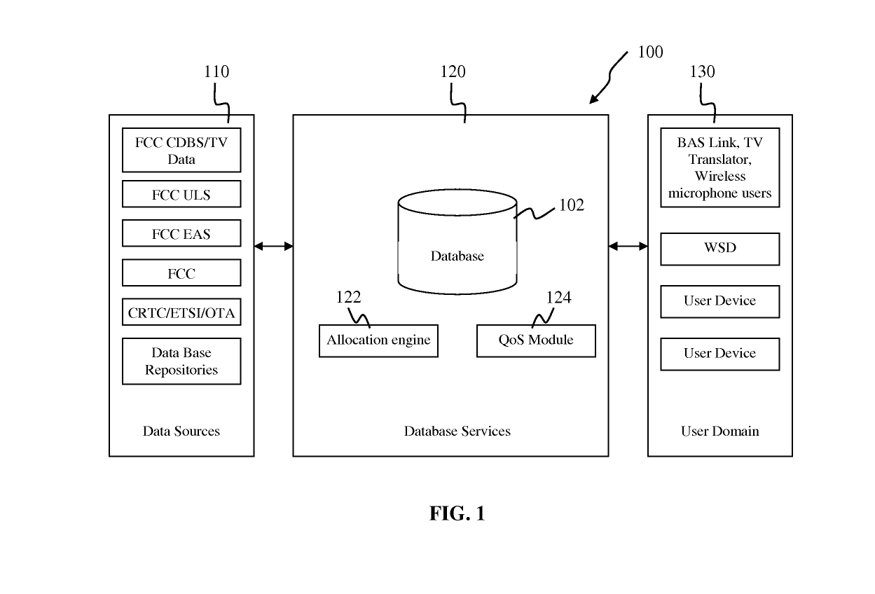

FIG. 1 illustrates a communication channel distribution system according to an embodiment. A GLDB management system 100 works as a querying system where a cognitive radio or TV white space device accesses a database 102 to obtain information on the available channels (or spectrum) at their location. The device can then select one of the available channels for communication.

In embodiments, information regarding available communication channels with respect to geographical location or geographical coverage is obtained from a plurality of data sources for provision to a database 102 for storage, organization and utilization. For example, such data sources 110 could be from the Federal Communications Commission (FCC) Consolidated Database System for TV data, the FCC Universal Licensing System, the FCC Emergency Alert System, the FCC, the Canadian Radio-Television Telecommunications Commission, European Telecommunications Standards Institute, and various other Over the Air regulators. Further, other repositories and database service providers can also provide such information for available communication channels to a database 102.

An added advantage of using the GLDB management system 100 is that it can allow the regulators to fine tune spectrum regulations or make spectrum changes by updating the parameters it passes on to the GLDB 100.

In embodiments, various data base services 120 are provided for a GLDB management system 100. Such services can be hosted and carried out with and on a provided processor system or various processor systems. In an embodiment, various white space database data base services are provided for a GLDB management system. Information from various data sources 110 are received and parsed through various conversion routines for standardization prior to entry into database 102. Information on available channels can also be run through a data sync module prior to entry into database 102. Information on various available channels can be continuously updated and synchronized with minimal difficulty for a continually updated representation of the telecommunication spectrum in a geographical location.

According to an embodiment, a database 102 can be provided to identify a plurality of communication channels accessible in relation to a geographical location. Further, in an embodiment, the database 102 can communicate with various data sources to obtain information pertaining to communication channels accessible in relation to a geographical location.

A computing system or a controller or a microcontroller or any other system providing a processing capability can be presented according to various embodiments in the present disclosure. Such a system can be taken to include a processor. The system according to various embodiments can include a controller which may include a memory which is for example used in the processing carried out by portions of the receiver. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with various alternative embodiments. Similarly, a “module” is thusly defined as a portion of a system according to various embodiments in the present disclosure and may encompass a “circuit” as above, or may be understood to be any kind of a logic-implementing entity therefrom. According to embodiments, the GLDB management system can include a processor and a memory. The GLDB can be hosted on a memory and operated by a processing system. Multiple processing systems and memory modules can also be hosted by the GLDB management system.

An allocation engine 122 can be provided and coupled to the database 102 for the appropriation and distribution of various available channels to devices upon request for the transmission or reception of wireless telecommunication signals. According to various embodiments, access requests are made to the database through message exchanges with a device requesting access. The allocation engine 122 can be operated with or coupled with various sorting and/or distribution algorithms for providing efficient allocation and distribution of the available channels.

In embodiments, the database services 120 can also include a partition or a module each for protected entity registration, for handling public access, and for white spaces service provider device interface access. Such partition or modules perform aliasing or coordination between the database 102 and various devices or utilities or entities requiring communication channel access for transmission and/or reception.

In embodiments, multiple devices or utilities or entities in a user domain 130 can request for access to available communication channels organized by the geo-location database 102. For example, broadcast auxiliary service links, TV translators, wireless microphone users and various other devices can communicate with the protected entity registration module which thereafter relays the communication requests to and through the allocation engine 122 for access information from the database 102.

Multiple white spaces devices (WSD) can also request for communication access with the GLDB 102 through the white spaces service provider device interface, which similarly communicates through the allocation engine 122 to the database 102. Further, publicly held devices can also obtain access through the public access portal service. Various available and satisfactory devices can also request for access to available communication channels and are generally classified as user devices.

GLDB can also provide certain provisions to incumbents such as broadcasters and program-making and special event (PMSE) users, e.g., wireless microphones operating in various frequencies.

According to an embodiment, the allocation engine 122 can include a QoS module 124. The QoS module 124 is provided to the allocation engine 122 so as to provide a capability to grant access to higher priority communication as part of a QoS support in the GLDB management system 100.

QoS can refer to a feature or aspect of a communications system that provides for the transport or data traffic with additional requirements. QoS can be understood to be the ability to provide different priorities to different applications, users, or data flows, or to support or guarantee a certain level of performance to a data flow. Quality of service guarantees are important if the network capacity is insufficient, especially for real-time streaming multimedia applications such as voice over IP, online games and IP-TV, since these often require fixed bit rate and are delay sensitive, and in networks where the capacity is a limited resource, for example in cellular data communication.

According to various embodiments, the QoS module 124 provides for the GLDB management system 100 to grant access to higher priority communication to licensed exempt systems. According to various embodiments, the QoS module 124 provides for the GLDB management system 100 to grant access to devices with higher priority communication to licensed exempt systems.

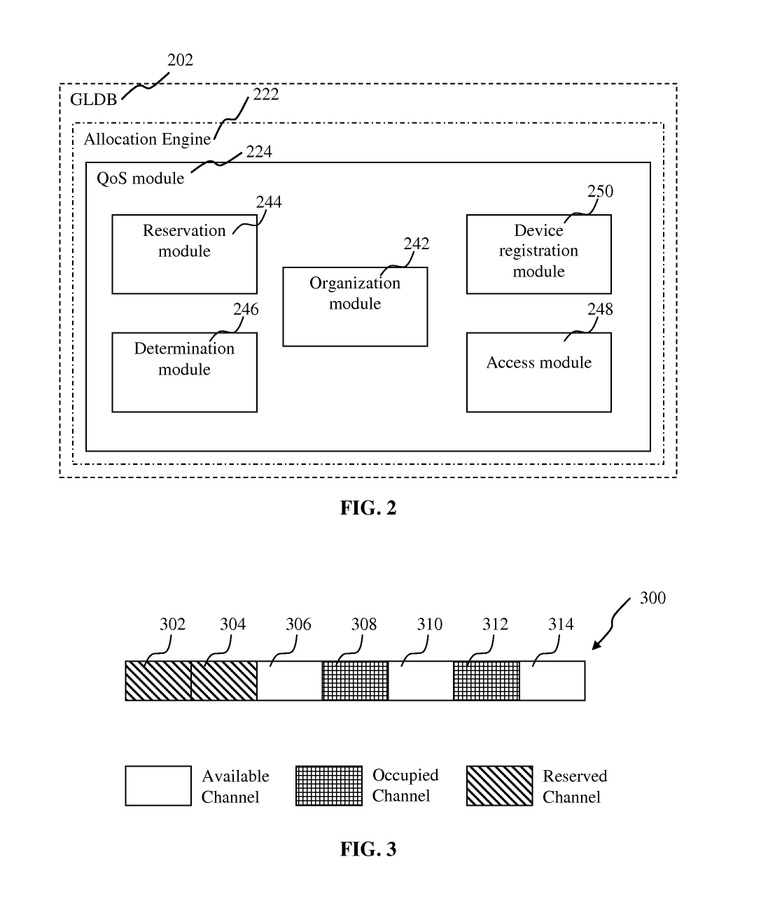

FIG. 2 illustrates a block diagram of a portion of an allocation engine according to an embodiment. The allocation engine 222 can include a QoS module 224 according to an embodiment. The QoS module 224 can be representatively included into an allocation engine of a GLDB management system as according to the embodiment of FIG. 1.

According to various embodiments, the QoS module 224 can include an organization module 242 for connection and interaction with a geo-location database (GLDB) 202. The organization module 242 can coordinate with another organization module inside the GLDB database 102 for channel organization. In various embodiments, the organization module 242 provides direct access into the GLDB 202 for organization access. According to various embodiments, the organization module 242 includes communication coupling with various data base service modules, such as the protected entity registration module, the public access module, and the WSSP device interface module. Such communication coupling is provided such that requests for data transmission and reception from the user domain can be parsed through the allocation engine 222 and the QoS module 224. In accordance to various embodiments in the present disclosure, a geo-location database provided with QoS capability can also be referred to as a GLDB-Q system.

According to an embodiment, the organization module 242 can provide manipulation of information for channels for accessing by various user domain devices. Further, the organization module 242 can interact with a status of indication of use of channels in a list as stored in a database 202 in the GLDB management system 100. According to an embodiment, a request for access to utilize a communication channel for transmission and/or reception is made from a user domain device to an allocation engine 122 of a GLDB management system 100. In an embodiment, the QoS module 224 processes the request made for access, and an organization module 242 in the QoS module carries out a utilization query with database 102 to determine the presence of an available channel. If so, the organization module 242 carries out a task to provide information for access to the access-requesting user domain device.

According to various embodiments, a QoS module 224 can include a reservation module 244, the reservation module 244 coupled to the earlier described organization module 242. The reservation module 244 is provided for access through the organization module 242 to the GLDB-Q 202 for classification for the restriction of access for communication channels available in a predetermined geographic location. In embodiments, the reservation module 244 provides a determination to set aside one or a plurality of communication channels and provides the information to the organization module 242. The organization module 242 thereafter receives the indication and identification of such channels and modifies an internal list or database entry to reflect such an indication.

According to an embodiment, the reservation module can be configured to carry out the reservation of vacant spectrum for restricted access. According to an embodiment, the GLDB management system can be configured to grant access to higher priority communication and/or devices with higher priority communication, via reserved vacant spectrum to licensed exempt systems based on a set of criteria pre-defined in order to maintain QoS of communication systems accessing licensed exempt spectrum. The set of criteria can be any one or more covers regulatory, technical and commercial aspects.

According to an embodiment, a reservation module can carry out a reservation of a communication channel for priority access without the database first identifying all communication channels accessible at a predetermined geographical location. For example, a sweep of information pertaining to all communication channels in the database could be carried out with respect to a predetermined location, and the results of the sweep identifying communication channels accessible at the predetermined location can be propagated in real time to the reservation module. The reservation module can thereafter allocate one or more of the identified communication channels on a “first-in” basis.

According to an embodiment, the QoS module 224 can include a determination module 246. The determination module 246 provides a verification function upon receipt of an access request from a user domain device. In an embodiment, the determination module 246 carries out a verification in response to an access request. The verification can be for any one of a device identification, a device registration, a channel usage, a channel registration request, a channel identification, a device and channel identification, etc. Upon satisfying a verification criteria, or a plurality of verification criteria, as predetermined in the determination module 246, the determination module 246 provides to the organization module 242 a signal to indicate the provision of a communication channel to the device requesting channel access.

According to an embodiment, whenever a device queries the GLDB-Q, the GLDB-Q will return a set of available channels for the device to use. The available spectrum here means spectrum that is not being occupied by primary users or incumbents. The set of vacant channels varies depending on the location of the device. A device will then select one or more of the vacant channels for communication.

Further, the determination module 246 carries out a verification based on at least one verification criteria and provides a user domain device with an available telecommunication channel. In embodiments, on satisfying a verification criteria, the GLDB management system provides a reserved communication channel to a user domain device requesting access.

According to an embodiment, the QoS module 224 can also include an access module 248, the access module configured to parse and provide information pertaining to an available channel made available for access to a user domain device. The access module 248 receives an indication from the determination module 246, either directly, or through the organization module 242. Further, the access module 248 can be coupled to the reservation module 242 to obtain information either directly from the reservation module 242 or the organization module 244 such as to provide an available channel for access.

According to an embodiment, the QoS module 224 can include a device registration module 250. The device registration module 250 handles registration of devices or a class of devices which handle urgent or priority communication. Pre-registration can be carried out with the registration module 250 of the GLDB management system such that a device or a class of devices can be registered in order to obtain access to QoS capability in the GLDB management system. In an embodiment, the registration module 250 can issue an unique device identification or a class identification to devices that are registered with the registration module 250. With the device identification, confirmation of registration during a later access request submitted by the registered device is simplified, only requiring a check in a registration log if a device requesting access has been registered. In an embodiment, the determination module 246 works in conjunction with the registration module 250 to verify if a device requesting communication channel access is pre-registered with the GLDB-Q 202 for handling priority communication.

According to various embodiments, any alternative layout of the QoS module of the allocation engine can be provided in accordance to the above description of the various modules as provided for carrying out various functions in the GLDB management system. In accordance to various embodiments, the features as discussed above and provided by the GLDB managing service can be excluded from the QoS module 224 and instead be provided in the allocation engine 222 or along the various other database services.

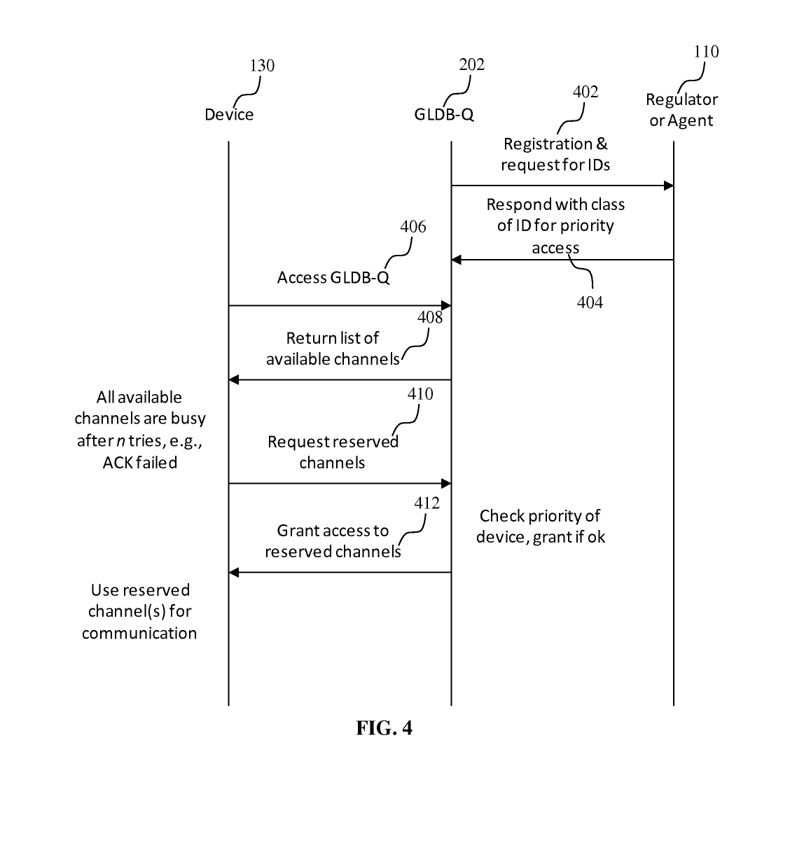

FIG. 3 illustrates a figurative representation of a range of communication channels according to an embodiment. The range 300 of communication channels includes a plurality of communication channels as stored and organized within the geo-location database 202. In a GLDB management system supporting for example, cognitive radio or a TV white space device applications, a range of communication channels 300 are allocated for dynamic access. Organization and allocation of channels in the range of communication channels 300 can be carried out by an allocation engine according to an embodiment. In embodiments, a QoS module in an allocation engine provides dynamic communication channel distribution for a GLDB management system. In an embodiment, one or more vacant channels are distributed to the requesting device for data communication access.

In an embodiment, when a user domain device queries the GLDB-Q 202 with an access request, the GLDB-Q will return a set of available or vacant channels for the device to use. Available channels can refer to a communication channel or a frequency spectrum for communication, that is not presently occupied by primary users or incumbents. The channel or a set of channels allocated to the device for access can vary in accordance to the device's geographical location. Further, the channel or set of channels allocated to the device for access can also be impacted by the type of channel or channels requested for. In FIG. 3, a range of channels 300 is illustrated, including channels 302-314, which representatively illustrates a number of channels within the GLDB-Q 202. The number of channels in the GLDB-Q need not be limited to the illustrative example of FIG. 3. In an embodiment, channels 308 and 312 are representatively indicated as being occupied or as occupied channels, or being in use with an application. As such, channels 302, 304, 306, 310 and 314 are representatively indicated as being vacant or available.

According to various embodiments, a reservation module in an allocation engine carries out a reservation of channels for urgent or priority communication, according to provided criteria or guidelines or regulations. In an embodiment, the number of channels to be reserved could be based on a regulatory parameter or based on any dynamic needs of certain locations. In an embodiment, the reservation module identifies vacant or available channels which have not been utilized and marks a number of the available channels as being reserved channels. In an embodiment, available channels 302 and 304 have been reserved or designated as reserved channels 302 and 304.

According to an embodiment, by designating a number of channels as reserved channels, a GLDB management system provides a partition of available communication channels for which QoS functionalities can be provided. In the event of urgent or priority communication, the GLDB management system can turn to the reserved channels for satisfying service guarantees in channel access and distribution.

According to various embodiments, when a device queries the GLDB management system, the system, by default, only uses the available channels for distribution and communication. In an embodiment, when a user domain device requires a communication channel to transmit or receive data, the GLDB-Q 02 will return any open and available channels. In an embodiment, in response to an access request, the GLDB-Q 202 will return any open and available channels, regardless of whether the data to be transmitted or received is classified urgent. In an embodiment, the remaining available channels 306, 310 and 314 are distributed for communication upon an incoming request from a user domain device.

In an embodiment, when the vacant channels are busy, or where there are no longer any available channels in the range communication channels, the user domain device will then request to use the reserved channels if the data to be sent or received is urgent. In an embodiment, when the available channels are depleted, the user device requests use of the reserved channels if the device is considered a high priority device. In an embodiment, the allocation of the reserved channels is based on a set of predefined criteria. In an embodiment, the allocation engine 222 of the GLDB-Q 202 allows access to the usage of reserved channels 302 and 304 to a requesting device if the device is a high priority device and/or the data is urgent, and when a set of predefined criteria is met.

In an embodiment, a high priority device can immediately access and utilize reserved channels for priority communication even when there are available communication channels. In an embodiment, when the a user device connects with the GLDB-Q 202 to obtain a communication channel for transmission or reception, the user device requests for a reserved communication channel instead of any available channel. The allocation of the reserved channels is still carried out based on a set of predefined criteria. The GLDB-Q 202 allows access to the usage of reserved channels if the device is a high priority device and/or the data is urgent, and if there is a pre-arranged allowance for such a decision to allow usage of reserved channels even in the availability of communication channels for distribution.

FIG. 4 illustrates a flow diagram of a channel distribution according to a first embodiment. GLDB management system includes communication between device 130, a geo-location database 202, and regulators and/or agents 110. According to an embodiment, GLDB-Q 202 includes an allocation engine 222, which can further include a QoS module 224 for the provision of a QoS capability for GLDB 102. In accordance to various embodiments in the present disclosure, a geo-location database provided with QoS capability can also be referred to as a GLDB-Q system 202.

According to an embodiment, predefined criteria for accessing reserved channels can be provided and stored in a determination module 246 of a QoS module 224. According to an embodiment, a regulatory and standardization control, or a regulatory approach is included as a criteria for accessing reserved channels. According an embodiment, a regulatory/standardization/certification body will certify devices based on their class of access and the need for urgent or priority communication, and information pertaining to such certification can be included with the QoS module 224. According to an embodiment, the QoS module 224 can include a registration module 250 which can implement the regulatory approach and identify and register devices satisfying the regulatory and standardization control.

In an embodiment, a special class identification (ID) can be issued for devices that meet the criteria to access the reserved channels. In an embodiment, the registration module 250 receives a class ID for various devices for registration. A possible class ID could for example be represented by using the certain portion of the ID bit fields of the device to determine the device priority level. As an example, if an ID consists of 6 Bytes, the first 1 Byte could be used to indicate the device priority level. The remainder bytes are for the identification of the device. In an embodiment, having a lower ID can indicate a higher device priority. For example, a device class ID of 0xOF XX XX XX XX XX (hexagonal representation) has a higher priority than 0x1A XX XX XX XX XX.

In carrying out a distribution of communication channels in response to a request from a device 130, information pertaining to the device 130 is obtained and passed to a determination module 246, which uses the device identification information to locate a device class ID as stored in the registration module 250. Once the device class ID is located, the first byte indicating priority is processed for determination whether a reserved channel can be made available to the requesting device.

According to an embodiment, a regulator 110 can set or provide a ‘threshold’ for class IDs to identify devices that are classified as having high priority. In an embodiment, the regulator 110 can provide a registration module 250 with a class ID which designates 0xFF as the first byte for devices that do not need any priority. The device class ID can also be combined with a service ID of a device depending on which service the device is currently trying to access.

Although the data comes from the same device, certain services require higher priority whilst certain services do not need real-time access. For example, a smart meter sending a meter reading may not need real-time access, whilst a meter tampering message sent by the smart meter should however be sent with a high priority.

According to an embodiment, a registration module 250 can carry out a registration process with a regulator or agent to identify a device or a class of devices which are considered priority devices and include these devices within a registration list or table within the registration module 250. In an embodiment, the registration module 250 is provided with a list of device class IDs by the regulator during the registration process. According to an embodiment, during the registration process, various services which can be undertaken by the device or the class of devices can be classified and registered within the registration module 250. In an embodiment, the registration module 250 is issued with one or more service IDs corresponding to various services for which the device can undertake in the delivery of data communication.

In an embodiment, a small fee may be imposed for registration of devices in order to deter devices which do not handle urgent or priority communication from accessing the reserved channels. In this case, only devices which have satisfied regulatory/standardization/certification requirements are able to access the reserved channels through the GLDB-Q 202. This frees up the reserved channels from access by non-urgent devices which also create interference with communications.

In 402, a registration module 250 initiates a registration with a regulator or agent 110 and requests for both device and service IDs. In 404, the regulator or agent 110 responds with class IDs for priority access for device and service. The received class ID information is stored within the registration module 250 for comparative access. It is also assumed that the regulator or agent 110 has already provided access and distribution control to the GLDB-Q for communication channel distribution.

In 406, a device 130 accesses the GLDB-Q system 202 to seek access to one or more communication channels for transmitting or receiving data communication. In 408, the GLDB-Q returns a list of available channels. However, should the list of available channels return null indicating that there are no available channels or should devices fail to access available channels, where for example, the available channel continuously provides a busy response after n number of attempts, the device can, in 410, request access to reserved channels for data communication. In another example, a user device can seek to connect to a seemingly available channel but fail to connect thereto if the actual quality of the communication channel which appears to be available is not suitable for communication.

Upon receiving a request for access to reserved channels, the GLDB-Q 202 obtains identification of the device 130 making the request and provides it to determination module 246, which carries out a device class ID location within the registration module 250. If a device class ID pertaining to the requesting device 130 is present, and the priority level of the device class ID allows for access to the reserved channels with respect to other devices requesting the GLDB-Q 202, the determination module 246 grants access for the device 130 to use a reserved channel for communication. In 412, the access module 248 is thereafter activated to grant access to the reserved channels and provide reserved channel information to the device 130 for transmission or reception access and data communication.

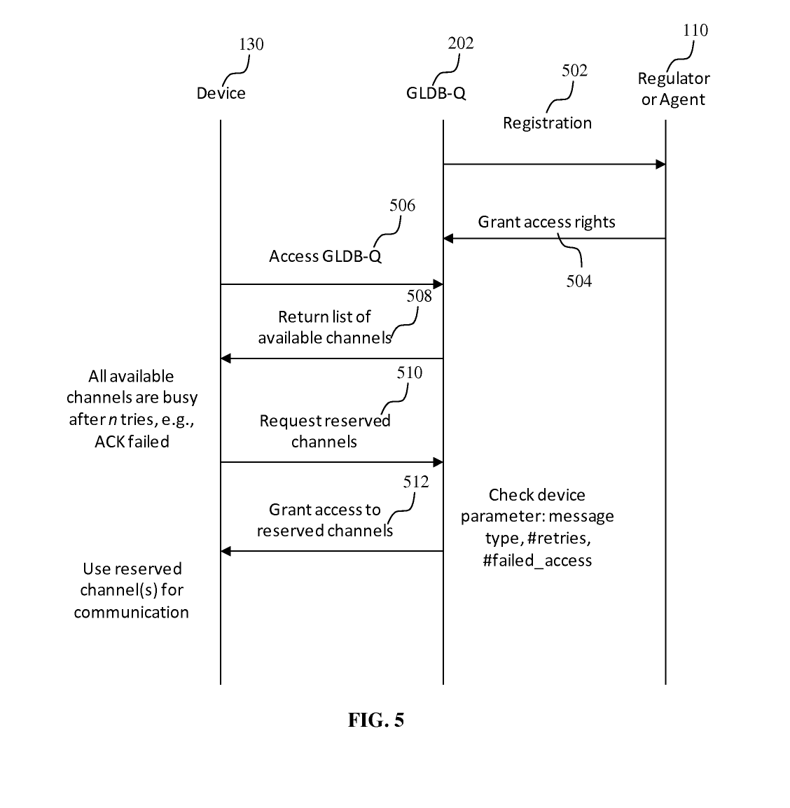

FIG. 5 illustrates a flow diagram of a channel distribution according to a second embodiment. According to an embodiment, a technical control, or a technical approach is included as a criteria for accessing reserved channels. As before, predefined criteria for accessing reserved channels can be provided and stored in a determination module 246 of a QoS module 224.

According to an embodiment, a device 110 which requires transmission or reception of urgent or priority communication may send a request to the GLDB-Q 202 to access the reserved channel either in real-time or as pre-negotiated, only after the list of available channels are fully occupied and cannot be used for communication. The GLDB-Q 202 may grant access to the reserved channels after certain technical criteria are met.

According to an embodiment, such criteria can for example be the GLDB-Q 202 analyzing channel access characteristics, such as receiving multiple feedback from various connecting devices that certain channels are busy; a device having re-tried connecting with a provided or distributed channel or channels for X number of times; or where the device includes an urgent-type or priority message to send, etc. In an embodiment, the technical criteria relate to characteristics of the channels as organized in the GLDB-Q 202. In an embodiment, the technical criteria relate to characteristics of the available channels, or channel access characteristics as organized in the GLDB-Q 202. According to an embodiment, the criteria can be based on channel access characteristics in relation to a requesting device 130.

Such criteria and information are stored and kept up-to-date in the determination module 246. In an embodiment, the type of communication and provided accesses can be recorded for post-processing and further improvements/auditing whenever required.

In 502, a GLDB-Q 202 initiates a registration with a regulator or agent 110. In 504, the regulator or agent 110 responds by granting access to the GLDB-Q for communication channel distribution.

In 506, a device 130 accesses the GLDB-Q system 202 to seek access to one or more communication channels for transmitting or receiving data communication. In 508, the GLDB-Q returns a list of available channels. However, should the list of available channels return null indicating that there are no available channels or should devices fail to access available channels, where for example, the available channel continuously provides a busy response after n number of attempts, the device can, in 510, request access to reserved channels for data communication.

Upon receiving a request for access to reserved channels, the determination module 246 of the GLDB-Q carries processing the request with respect to the predetermined technical criteria. For example, the determination module 246 checks device parameters with the registration module, the message type of the device, the number of retries if a seemingly available channel cannot be connected with, or with reasons for failed access onto a provided communication channel. If the predetermined criteria can be satisfied by the request from the device 130, the determination module 246 grants access for the device 130 to use a reserved channel for communication. In 512, the access module 248 is thereafter activated to grant access to the reserved channels and provide reserved channel information to the device 130 for transmission or reception access and data communication.

According to an embodiment, the GLDB-Q 202 can carry out a process of pre-negotiation in channel distribution. In carrying out pre-negotiation, the GLDB-Q 202 can indicate and provide the criteria for reserved channel access in advance to connecting devices. In an embodiment, the criteria can include items such as the number of retries, number of ACK failures, etc. Whenever the device 130 meets these criteria, it is able to access a reserved channel by sending a request or notification to the GLDB-Q 202 informing so.

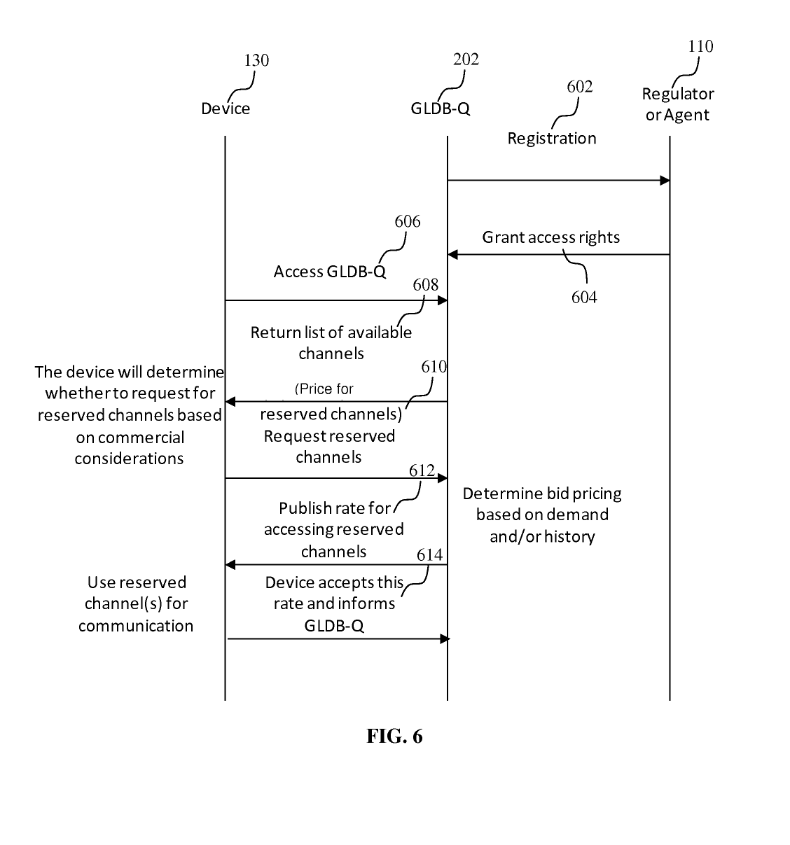

FIG. 6 illustrates a flow diagram of a channel distribution according to a third embodiment. According to an embodiment, a market-drive or demand-based approach is included as a criteria for accessing reserved channels. As before, predefined criteria for accessing reserved channels can be provided and stored in a determination module 246 of a QoS module 224.

According to an embodiment, a small fee is imposed whenever a device accesses a reserved channel. In an embodiment, the fee amount can be adjusted based on a demand for channel access. Coming up with a small fee to access reserved communication channels for priority communication may be acceptable, especially for devices which perhaps have a great need to access communication channels for urgent or priority communication. In such a case, unnecessary access to the reserved channels can be deterred, especially when the vacant channels are still usable. Various mechanisms can be adopted with regard to fee settlement in the implementation of such a market-driven approach.

In an embodiment, the GLDB-Q 202 can further implement a bidding system in the provision of access to reserved channels for communication. In an embodiment, a device can increase a bid up to a reserve bid price to obtain access to a reserved communication channel over other devices. The fee for obtaining access to the reserved channel can thus dynamically change with respect to the supply of available communication channels and the demand from devices requiring channel access.

According to an embodiment, In 602, a GLDB-Q 202 initiates a registration with a regulator or agent 110. In 604, the regulator or agent 110 responds by granting access to the GLDB-Q for communication channel distribution.

In 606, a device 130 accesses the GLDB-Q system 202 to seek access to one or more communication channels for transmitting or receiving data communication. In 608, the GLDB-Q 202 returns a list of available channels. In an embodiment, the price or fee for accessing reserved channels can also be provided by the GLDB-Q 202 to the requesting device 130. The access fee can be a minimum fee for access. In 610, the device 130 can request access to reserved channels, together with a confirmation of acceptance of the provided fee for accessing reserved channels.

According to an embodiment, the GLDB-Q 202 can further increase a bid pricing for a fee to access a communication channel based on demand and/or history. If such a fee increase is carried out, in 612, the fee rate for accessing reserved channels is published and informed to device 130. In undertaking such a market-driven approach, where a device undertakes the payment of a fee for obtaining access to a communications channel, the device is provided with either a flexibility to acknowledge and accept fee increases, or is provided with access to a device operator which provides the acceptance of such fee increases. If the fee pricing is agreeable, in 614, the device 130 accepts the published rate and informs GLDB-Q 202 thereafter. The access module 248 is thereafter activated to grant access to the reserved channels and provide reserved channel information to the device 130 for transmission or reception access and data communication.

According to an embodiment, the determination module 246 can include a pricing module for the handling of such a market-driven approach in providing access to reserved channels. In an embodiment, the pricing module can further include a bidding module configured to carry out various bidding schemes. In other embodiments, the pricing module can also be configured to carry out other market-driven approaches in controlling access to reserved channels.

According to an embodiment, various features or approaches can be combined to ensure better spectrum utilization while maintaining QoS via the GLDB-Q. In an embodiment, the GLDB-Q 202 or administrators to the GLDB-Q 202 are allowed to change the number of reserved channels under certain guidelines provided by the regulators. According to an embodiment, a fixed allocation approach is used in the handling of channel reservation. In an embodiment, a regulator can fix a certain number of channels as reserved channels. In doing so, the GLDB-Q 202 is not provided with the prerogative to change the number of channels under reservation. When it is so required, for example, when demand outweighs supply, the GLDB-Q 202 has to request the regulator for increasing the number of reserve channels as designated by the regulator accordingly. In an embodiment, the GLDB-Q 202 can present a number of requests at a time interval to justify a need to increase the number of reserved channels.

According to an embodiment, a semi-dynamic allocation approach is used in the handling of channel reservation. In an embodiment, the GLDB-Q 202 is allowed to change the number of reserved channels based on a range of reserved channels provided by the regulator. In this case, the GLDB-Q 202 can determine a current number of reserved channels based on real-time demand from the devices. In an embodiment, the GLDB-Q 202 can reserve as few reserved channels as possible, to allow more available channels for smooth communication.

According to an embodiment, a fully-dynamic allocation approach can be used in the handling of channel reservation. In an embodiment, the GLDB-Q 202 is provided with the liberty to change the number of reserved channels, up to a predetermined number of reserved channels. In an embodiment, the GLDB-Q 202 can change the number of reserved channels up to the maximum number of channels available. In this case, the GLDB-Q 202 can determine the number of reserved channels based on real-time demand from the devices.

According to various embodiments, the GLDB-Q can include one or more of the above discussed features or approaches in determining the satisfaction of criteria in obtaining reserved channel access.

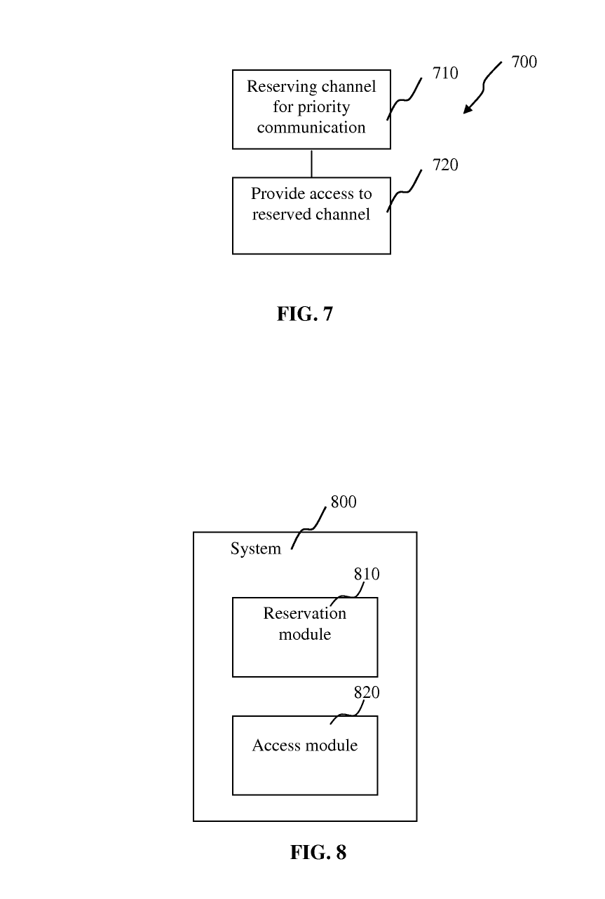

FIG. 7 illustrates a block diagram of a method 700 according to an embodiment of the present disclosure. Method 700 can be a method for communication channel distribution in a telecommunications frequency spectrum. In 710, the method can include reserving, for a predetermined geographical location, at least one communication channel accessible at the predetermined geographical location for priority communication. In 720, the method can include providing access to the at least one communication channel reserved for priority communication when a priority request criteria is satisfied.

Such a method as provided and described in embodiments of the present disclosure advantageously provides a capability for Quality of Service (QoS) operation for shared spectrum communications and management. Such QoS capabilities are highly regarded in consideration of high value, high priority data communications, which desire for a regulator or a service provider to even grant performance or operational guarantees in the accessibility and quality of communication channels. Other advantages include the efficient use of reserved vacant spectrum, either from the current pool of licensed exempt spectrum, or from another set of spectrum identified by the regulator; utilization of a licensed-exempt device to use the reserved vacant spectrum for ‘urgent’ transmission so as to maintain QoS requirements; and control of permission for accessing the reserved vacant spectrum through various criteria such as regulatory, technical or commercial criteria.

In an embodiment, the method can include receiving communication channel information from a service provider and compiling the communication channel information as a database of communication channels. In an embodiment, the method can include identifying, for a predetermined position, a plurality of communication channels accessible at the predetermined geographical location. In an embodiment, the method can include organizing the plurality of communication channels accessible at the predetermined geographical location for access distribution.

In an embodiment, the method further includes verifying an identification of a requesting device with a register of identification codes relating to authorized devices for reserved channel access in checking the satisfaction of the priority request criteria.

In an embodiment, the method further includes determining satisfaction of the priority request criteria based on a priority indication of an identification code for the requesting device.

In an embodiment, the method further includes verifying an identification of a service application for the requesting device with a register of identification codes relating to service applications run by authorized devices for reserved channel access.

In an embodiment, the method further includes analyzing channel access characteristics in relation to a requesting device in checking the satisfaction of the priority request criteria.

In an embodiment, the method further includes providing the priority request criteria to a requesting device, and making a request for access to the at least one communication channel reserved for priority communication only when the priority request criteria is satisfied.

In an embodiment, the method further includes making a fee payment for access to the at least one communication channel reserved for priority communication in satisfying the priority request criteria.

In an embodiment, the method further includes complying with a bidding scheme in making the fee payment for access to the at least one communication channel reserved for priority communication in satisfying the priority request criteria.

In an embodiment, the method further includes reserving a number of communication channels for priority communication, and changing the number of communication channels reserved for priority communication based on a demand for communication channel access.

In an embodiment, the method further includes identifying, for the predetermined geographical location, a plurality of communication channels accessible at the predetermined geographical location; and reserving all of the plurality of communication channels for priority communication.

FIG. 8 illustrates a block schematic of a system for communication channel distribution in a telecommunications frequency spectrum according to an embodiment of the present disclosure. According to an embodiment, there is provided of a system 800 for communication channel distribution in a telecommunications frequency spectrum. The system 800 includes a reservation module 830 configured to reserve, for a predetermined geographical location, at least one communication channel accessible at the predetermined geographical location for priority communication; and an access module 840 configured to provide access to the at least one communication channel reserved for priority communication when a priority request criteria is satisfied.

In an embodiment, the system includes a determination module configured to verify an identification of a requesting device with a register of identification codes relating to authorized devices for reserved channel access in checking the satisfaction of the priority request criteria.

In an embodiment, the identification code comprises a priority indication for reserved channel access for the requesting device.

In an embodiment, the system includes a register of identification codes relating to service applications run by authorized devices for reserved channel access.

In an embodiment, the system includes a determination module configured to analyze channel access characteristics in relation to a requesting device in checking the satisfaction of the priority request criteria.

In an embodiment, the system includes a determination module configured to provide the priority request criteria to a requesting device, and to receive a request for access to the at least one communication channel reserved for priority communication only when the priority request criteria is satisfied.

In an embodiment, the system includes a pricing module configured to receive a fee payment for access to the at least one communication channel reserved for priority communication from a requesting device.

In an embodiment, the system includes a bidding module configured to receive bids from the requesting device according to a bidding scheme in making the fee payment for access to the at least one communication channel reserved for priority communication.

In an embodiment, the system includes a reservation module configured to reserve a number of communication channels for priority communication, and to change the number of communication channels reserved for priority communication based on a demand for communication channel access.

In an embodiment, the system further includes an organization module configured to identify, for the predetermined geographical location, a plurality of communication channels accessible at the predetermined geographical location; and the reservation module reserves all of the plurality of communication channels for priority communication.

The above apparatus, method and/or system as described and illustrated in the corresponding figures, is not intended to limit an or any apparatus, method or system as according to an embodiment, and the scope of the present disclosure. The description further includes, either explicitly or implicitly, various features and advantages of the method or system according to the present disclosure, which can be encompassed within an apparatus, method or system according to the disclosure.

While embodiments of the disclosure have been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A method for communication channel distribution in a telecommunications frequency spectrum comprising:
reserving, for a predetermined geographical location, at least one communication channel for priority communication; and accessible at the predetermined geographical location
providing access to the at least one communication channel reserved for priority communication when a priority request criteria is satisfied.

2. The method according to claim 1, further comprising verifying an identification of a requesting device with a register of identification codes relating to authorized devices for reserved channel access in checking the satisfaction of the priority request criteria.

3. The method according to claim 2, further comprising determining satisfaction of the priority request criteria based on a priority indication of an identification code for the requesting device.

4. The method according to claim 2, further comprising verifying an identification of a service application for the requesting device with a register of identification codes relating to service applications run by authorized devices for reserved channel access.

5. The method according to claim 1, further comprising analyzing channel access characteristics in relation to a requesting device in checking the satisfaction of the priority request criteria.

6. The method according to claim 1, further comprising providing the priority request criteria to a requesting device, and making a request for access to the at least one communication channel reserved for priority communication only when the priority request criteria is satisfied.

7. The method according to claim 1, further comprising making a fee payment for access to the at least one communication channel reserved for priority communication in satisfying the priority request criteria.

8. The method according to claim 7, further comprising complying with a bidding scheme in making the fee payment for access to the at least one communication channel reserved for priority communication in satisfying the priority request criteria.

9. The method according to claim 1, further comprising reserving a number of communication channels for priority communication, and changing the number of communication channels reserved for priority communication based on a demand for communication channel access.

10. The method according to claim 9, further comprising:
identifying, for the predetermined geographical location, a plurality of communication channels accessible at the predetermined geographical location; and
reserving all of the plurality of communication channels for priority communication.

11. A system for communication channel distribution in a telecommunications frequency spectrum, comprising:
a reservation module configured to reserve, for a predetermined geographical location, at least one communication channel accessible at the predetermined geographical location for priority communication; and
an access module configured to provide access to the at least one communication channel reserved for priority communication when a priority request criteria is satisfied.

12. The system according to claim 11, further comprising a determination module configured to verify an identification of a requesting device with a register of identification codes relating to authorized devices for reserved channel access in checking the satisfaction of the priority request criteria.

13. The system according to claim 12, wherein the identification code comprises a priority indication for reserved channel access for the requesting device.

14. The system according to claim 12, further comprising a register of identification codes relating to service applications run by authorized devices for reserved channel access.

15. The system according to claim 11, further comprising a determination module configured to analyze channel access characteristics in relation to a requesting device in checking the satisfaction of the priority request criteria.

16. The system according to claim 11, further comprising a determination module configured to provide the priority request criteria to a requesting device, and to receive a request for access to the at least one communication channel reserved for priority communication only when the priority request criteria is satisfied.

17. The system according to claim 11, further comprising a pricing module configured to receive a fee payment for access to the at least one communication channel reserved for priority communication from a requesting device.

18. The system according to claim 17, further comprising a bidding module configured to receive bids from the requesting device according to a bidding scheme in making the fee payment for access to the at least one communication channel reserved for priority communication.

19. The system according to claim 11, further comprising a reservation module configured to reserve a number of communication channels for priority communication, and to change the number of communication channels reserved for priority communication based on a demand for communication channel access.

20. The system according to claim 19, further comprising an organization module configured to identify, for the predetermined geographical location, a plurality of communication channels accessible at the predetermined geographical location; and wherein the reservation module reserves all of the plurality of communication channels for priority communication.
